(19) United States
(12) Patent Application Publication
(10) Pub. No.: US 2025/0350159 A1
(43) Pub. Date: Nov. 13, 2025

(54) Slotless Electric Motor Having Segmented Stator

(71) Applicant: Hinetics, Inc., Champaign, IL (US)

(72) Inventors: Samith Sirimanna, Urbana, IL (US); Thanatheepan Balachandran, Savoy, IL (US); Phoenix Bauer, Champaign, IL (US); Kiruba S. Haran, Champaign, IL (US)

(21) Appl. No.: 19/200,414

(22) Filed: May 6, 2025

Related U.S. Application Data
(60) Provisional application No. 63/643,540, filed on May 7, 2024.

(51) Int. Cl. H02K 1/14; H02K 5/00

(52) U.S. Cl. CPC H02K 1/14; H02K 5/00

(57) ABSTRACT

A slotless electric motor provides a segmented winding assembly with winding modules attached to each other and attached to a circumferential side wall of a stator body. An interlock system mechanically locates the winding modules in predetermined positions relative to the stator body.

### CROSS REFERENCE TO RELATED APPLICATION

This application claims the benefit of U.S. provisional application 63/643,540 filed May 7, 2025, and hereby incorporated by reference.

### FIELD OF THE INVENTION

The present invention relates to electrical machines and in particular to a slotless electric motor having improved reliability and manufacturability.

### BACKGROUND OF THE INVENTION

Electrical motors for aircraft application require high efficiency, for example, to take advantage of energy storage devices such as batteries and the like, and high specific power (power per weight) to reduce unnecessary aircraft weight.

Commonly owned U.S. Pat. No. 11,799,363, incorporated by reference, describes a slotless electric motor in an aircraft implementation with improved transient capabilities.

Slotless motor stators incorporate windings that are form-wound. However, implementing form-wound windings presents numerous challenges, including aspects related to insulation and alignment. A winding's performance characteristics and reliability are highly dependent on the integrity of its insulation. Although windings must be highly electrically insulated, excessive insulation can lead to degradation of various performance characteristics such as compromised power density and thermal performance.

Insulating form-wound windings may be achieved by impregnating them with an insulating resin, which dries to form an insulative encapsulation during a casting procedure. However, applying an appropriate amount of insulation to form-wound windings can be challenging, especially applying an appropriate amount of resin to a winding's end loops or turns, or end winding sections, because of their complex geometries. Manual mixing of resin and/or applying it while casting can produce entrapped air bubbles and voids incorporated into the dried encapsulation that can compromise the insulation's electrical insulative and thermal conductivity characteristics. This is further complicated by various winding phases that require manufacturing windings in corresponding different lengths for end loops to facilitate the winding-overlap. This can require different casting molds, additional manufacturing steps for different phase windings, and the longer end loops add weight and resistive losses to the windings. Furthermore, if air-cooling is used for thermal management, the end loops are left exposed to environmental conditions such as humidity and dust that can compromise the insulation's integrity.

After casting form-wound windings, mounting the encapsulated structures to the motor presents additional challenges related to fitment and dimensional tolerances. The windings' cast encapsulations tend to have dimensional variations, both in terms of overall casting dimensions and the exact position/orientation of the conductive coil material of the windings within the encapsulation. When the numerous windings are installed on the motor, these dimensional/positional variations stack up, which may lead to overall or accumulated discrepancies between actual configuration(s) dimensions and design tolerance(s) that may be less than desirable. This may include accumulated orientation discrepancies, such as slight angular misalignment(s) in the axial direction at one or more winding that can create similar or worsen angular misalignment(s) of adjacent windings. Such misalignments potentially create fitment difficulties of the last winding(s) to be mounted. Besides fitment difficulties, winding distribution irregularities around a stator can be detrimental and create, for example, unacceptably large circulating current values

Winding arrangements with suitable insulative properties for form-wound winding can be obtained by encapsulating the winding's conductive coils. In recent years, encapsulating windings has been performed, however, commercial implementation and mass-producibility of insulation-encapsulated windings that can facilitate motor-installation while improving fit and dimensional consistency remains difficult.

### SUMMARY OF THE INVENTION

The present invention provides a slotless electrical motor with a segmented winding assembly that incorporates mounting and/or alignment features such as a chamber or channel integrated in each winding module body and/or an alignment interlock that locates the module body with respect to the motor's stator. This approach facilitates expedited winding installation and orientation consistency by providing mechanical alignment interfaces between the stator and module body that reduce alignment variability. The module bodies may include end segments with increased thicknesses that accommodate insulative encapsulation of end-loops, including end-loops that are angled with respect to adjacent straight winding segments. The thicker end segments may have block-like configurations that present shoulders or abutment surfaces defining boundaries of the chamber, which may have a channel-like configuration, that may facilitate locating the module body with respect to the motor's stator. The alignment interlock provides further alignment through cooperating features such as corresponding projections and receptacles of the module body and stator component(s) such as its stator body.

Specifically, the present invention provides in one embodiment a slotless electric machine having a rotor mounted for rotation about an axis and a stator positioned adjacent to the rotor and providing a stator body with a pair of end surfaces or faces that extend from the circumferential side wall radially inward toward the stator's central axis. A segmented winding assembly has multiple winding modules that are connected to each other and extend about the stator body. Each winding module includes a module body with first and second side walls that face adjacent first and second winding modules. An outer segment of the module body is arranged away from the stator body and the module body's inner segment is arranged toward the stator body with a chamber provided in the module body's inner segment. The chamber is configured to locate the module body with respect to the stator body by receiving a portion of the stator body's circumferential side wall in it.

It is thus a feature of at least one embodiment of the invention to provide a simplified manufacture of a slotless motor by providing a segmented winding assembly that has module bodies that can be mechanically aligned during fitment to ensure acceptable orientation, spacing, and other dimensional characteristics of the overall stator assemblage.

The module bodies of the winding modules may include end portions that are thicker than their intermediate portions. The windings straight winding sections may be arranged in the intermediate portions and define active sections of the winding modules. The windings' end loops may be arranged in the thicker end portions of the winding modules.

It is thus a feature of at least one embodiment to provide a stator with poly-phase winding pole sections provided by winding modules that are each completely potted or encapsulated, including their end loops or end windings.

The stator body may include a stack of laminations such as iron laminations in a ferrous stator body implementation and its circumferential side wall may be defined by a stator yoke. The stator body may instead be non-ferrous, such as when implemented as an air-core type motor with non-ferrous materials which may include various composite materials and/or other non-magnetic materials. The winding modules may be attached, such as by adhesion, directly to the stator yoke and to each other to provide the overall winding assembly of the stator. A resin such as an epoxy may be used to adhesively attach the winding modules to the stator yoke and each other.

It is thus a feature of at least one embodiment of the invention to provide a slotless stator with modular windings or winding modules and compact configurations, along with reduced electro-thermal stresses. The fully encapsulated and mechanically registrable winding modules have improved thermal degradation, insulation quality, and partial discharge while retaining high power density and system-level benefits of air-cooled configurations over liquid cooling.

It is thus a feature of at least one embodiment of the invention to facilitate mass production and operation or manufacturability of winding modules that may be incorporated into a high insulation machine(s) that can be used in aircraft propulsion.

It is thus a feature of at least one embodiment of the invention to provide a segmented winding assembly with modularity or a modular-based winding that simplifies repairing winding faults in situations of compromises insulation.

These particular objects and advantages may apply to only some embodiments falling within the claims and thus do not define the scope of the invention.

### BRIEF DESCRIPTION OF THE FIGURES

FIG. 1 is a simplified block diagram of an airplane employing the slotless electric motor of the present invention and providing expanded views of the basic motor structure and coil or winding assembly of that motor structure;

FIG. 2 is a partially exploded view of a stator with a segmented winding assembly of the present invention;

FIG. 3 is an isometric view of a winding module of the present invention;

FIG. 4 is a cross-sectional view of a portion of a slotless electric motor of the present invention;

FIG. 5 is an isometric view of form-wound windings; and

FIG. 6 is an isometric view of a schematic representation of a mold for making a winding module of the present invention.

### DETAILED DESCRIPTION OF THE PREFERRED EMBODIMENTS

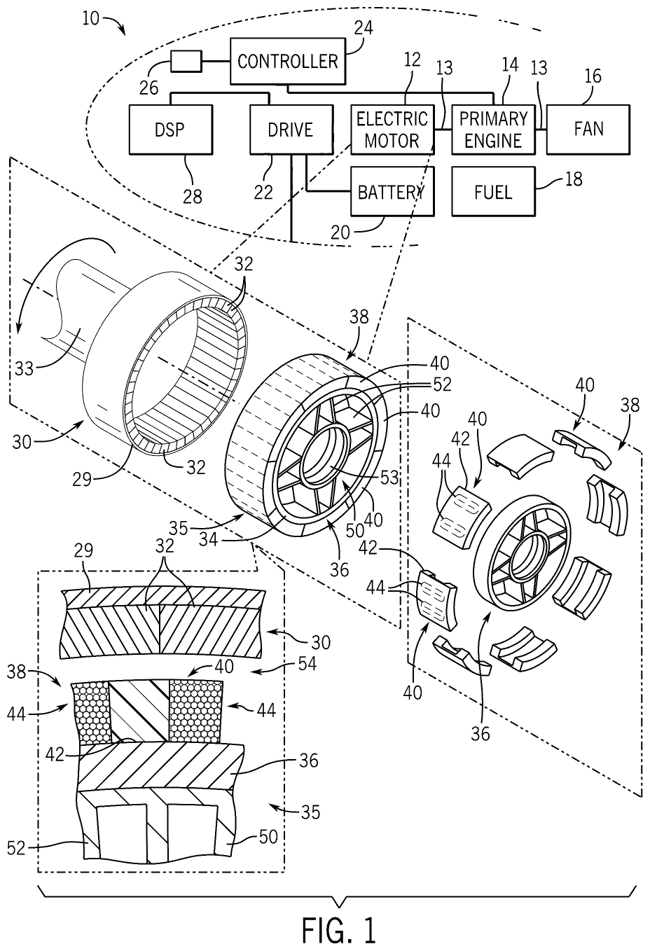

Referring now to FIG. 1 the present invention may be incorporated into the aircraft 10 having different prime movers of an electric motor 12 operating in conjunction with a fuel-burning primary engine 14 such as a gas turbine or the like. Together or individually the electric motor 12 and the primary engine 14 may drive a fan 16 such as a turbo fan, propeller, or the like.

During most of the flight of the aircraft 10, power may be provided by the primary engine 14 consuming hydrocarbon fuel 18. The electric motor 12 will typically be used episodically, for example, during power-demanding takeoff of the aircraft, drawing power during these times from a set of batteries 20 which may be recharged during the remainder of the flight by a generator set (not shown) associated with the primary engine 14. In a direct drive design as shown, a common driveshaft 13 may communicate between the electric motor 12, the primary engine 14, and the fan 16; however, the invention also contemplates interconnecting drive systems having intervening clutches and gearboxes.

The electric motor 12 may be associated with a motor drive 22, for example, a solid-state drive processing power from the batteries 20 to provide the necessary voltages and phases for multiple motor windings, the latter as will be described. The motor drive 22 may communicate with an aircraft controller 24 serving to coordinate operation of the electric motor 12 and primary engine 14 according to command signals (throttle etc.) received by flight controls 26 from the pilot or an autopilot or the like. The motor drive 22 may provide information to the aircraft controller 24 for the purpose of coordinating the operation of the electric motor 12 and primary engine 14 and may provide display information in a cockpit display 28.

Referring still to FIG. 1, the electric motor 12 in a preferred embodiment is shown as a slotless-winding, outer-rotor, air-cooled permanent magnet synchronous motor (PMSM) having an external rotor 30 rotatably mounted on bearings (not shown) to turn a driveshaft 33 that may provide mechanical power to the fan 16. It is understood that the motor 12 may instead be an in-runner or inner-rotor configuration. It is further understood that motor 12 may be implemented as a superconducting machine or motor instead of a PMSM motor. The rotor 30 may provide a generally cylindrical tubular shell 29 having permanent magnets 32 lining its interior surface, for example, including magnets having a radial orientation of their north-south axes, for example, in parts of a Halbach array, the latter configuration eliminating the need for ferrous material in the rotor 30. The tubular shell 29 may, for example, be a non-magnetic material that has low density and high strength (e.g., titanium) that may continue to the unitary drive shaft 33 supported by bearings (not shown) as well as provide a container for the permanent magnets 32 against the centrifugal forces.

Still referring to FIG. 1, fitting within the rotor 30 is a stationary stator 35, for example, having a flange 34 for mounting it to a fixed structure of the aircraft 10. The stator 35 may include cylindrical support structure shown as a stator body 36 holding on its outer periphery a segmented winding assembly 38 that provides winding modules 40 with module bodies 42 that encapsulate coils or windings 44. Stator body 36 may be implemented as either a ferrous stator body or a non-ferrous stator body that includes, for example, various composite materials and/or other non-magnetic materials. The winding modules 40 are attached to each other and the stator body 36 to arrange their respective windings 44 as an angularly spaced array of coils or windings 44. Each coil or winding 44 is constructed of multiple turns of an electrical conductor such as copper about radial axes to provide a radially-oriented magnetic field with current flow through the windings 44.

Still referring to FIG. 1, generally, each winding module 40 will have an outer face passing closely adjacent to the inner surface of the magnets 32, spaced by an air gap 54. An inner face of each winding module 40 may be attached directly, for example, by epoxy or the like, to the stator body 36. The winding modules 40 and their windings 44 are arranged around the circumference of the stator body 36 without intervening ferromagnetic material eliminating the need for stator lamination slots or teeth. Magnetic flux directed radially inward from the inner face of the windings 44 is conducted by the high-permeability, low-loss material of the stator body 36, for example, being thin layers of silicon steel or other ferrous materials such as a stack of iron laminations.

The stator body 36 may be tubular and fitted around a heatsink assembly 50 having multiple radial fins 52 allowing dissipation of heat conducted from the windings 44 through the stator body 36 into the heatsink assembly 50 to pass in turn to air moving axially along the fins 52 under the influence of a contained fan (not shown). Each of the fins 52 may extend radially from a central cylindrical chamber 53. The heatsink assembly 50 is preferably a lightweight non-ferromagnetic material with high thermal conductivity characteristics such as aluminum.

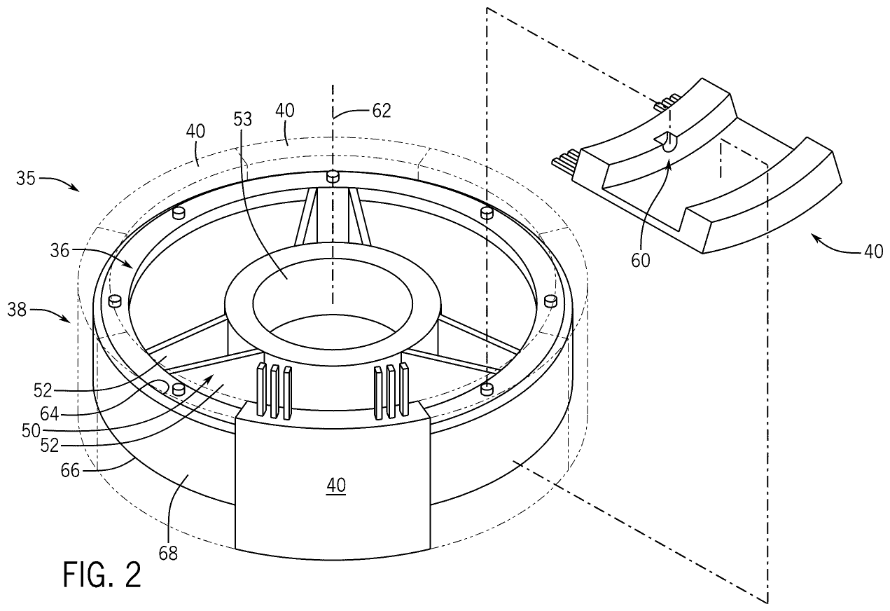

Referring now to FIG. 2, interlock system 60 mechanically locates each winding module 40 in a predetermined position with respect to the stator body 36. The predetermined positions are established by cooperative features that engage each other on the stator body 36 and each winding module 40.

Still referring to FIG. 2, stator body 36 defines a central axis 62 and a pair of end surfaces or first and second faces 64, 66. The stator body faces 64, 66 are shown here as ring-shaped or annular with circular outer and inner perimeters. Each of the faces 64, 66 extends radially inward from its outer perimeter toward central axis 62, with respective inner perimeters of faces 64, 66 connected to heatsink assembly 50. A cylindrical circumferential side wall extends in an axial direction concentrically about central axis 62 between faces 64, 66, joining the faces 64, 66 at their outer perimeters. The circumferential sidewall is shown here as stator yoke 68, upon which the series of winding modules 40 is attached, typically by way of an adhesive such as an epoxy, to provide the segmented winding assembly 38.

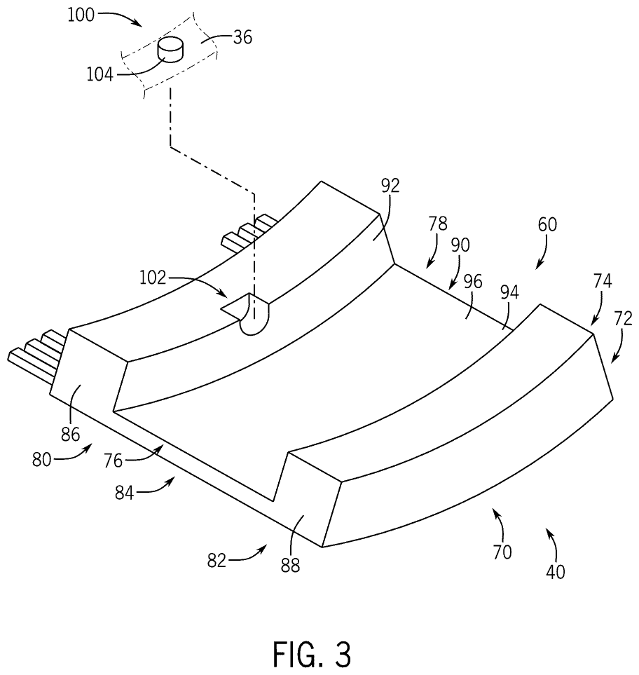

Referring now to FIG. 3, winding module 40 provides a module body 70 which is made from an insulative material, typically a polymeric resin. Module body 70 has a generally curved profile when viewed from a side elevation with a radius of curvature that corresponds to that of stator yoke 68. Module body 70 has radial outer and inner segments 72, 74 that respectively face away from and toward the stator central axis (FIG. 2). First and second side walls 76, 78 face away from each other and in the full assemblage of segmented winding assembly 38 (FIG. 1) engage and are typically adhered to corresponding side walls of respective adjacent module bodies 70. Module body 70 has ends or first and second end portions 80, 82 with an intermediate portion 84 between the end portions 80, 82. When viewed in cross-section, or from an elevated view of one of the side walls 76, 78, module body 70 has different thicknesses across its width. Ends or end portions 80, 82 are thicker than intermediate portion 84 and define end blocks 86, 88. An outer surface of outer segment 72 provides a continuously curving surface of module body 70 at a constant radial distance from central axis 62 (FIG. 2). An inner surface of inner segment 74 is stepped, with the surface segments at end portions, 80 82 being closer to central axis 62 (FIG. 2) than the surface of intermediate portion 84 as a recessed portion relative to end blocks 86, 88. The recessed portion of module body 70 provides a chamber, shown as channel 90 of interlock system 60, that receives a portion of stator body 36 (FIG. 2) between the end blocks 86, 88. Channel 90 has a boundary defined by a generally U-shaped interconnection of a pair of inner side walls 92, 94 of end blocks 86, 88 and an inner circumferential wall 96 of intermediate section 84. In the fully assembled segmented winding assembly 38, the aligned channels 90 of the attached winding modules 40 provide a continuous inner circumferential groove or channel in which stator yoke 68 is nested between continuous rings defined by the connected respective end blocks 86, 88.

Still referring to FIG. 3, interlock system 60 further includes alignment interlock 100, shown here with cooperating receptacles and projections that engage each other to locate winding module 40 with respect to stator body 36. Receptacle 102 is shown as a depression extending into end block 86, with a curved bottom wall, three interconnected side walls extending from the bottom wall, and a side opening that opens into channel 90 of winding module 40. Alignment interlock's 100 projection is shown here as post 104 that extends from stator body 36. Receptacle 102 and post 104 are sized and configured to engage each other with sufficient snugness to ensure adequate registration and alignment of the winding modules 40 upon the stator body 36.

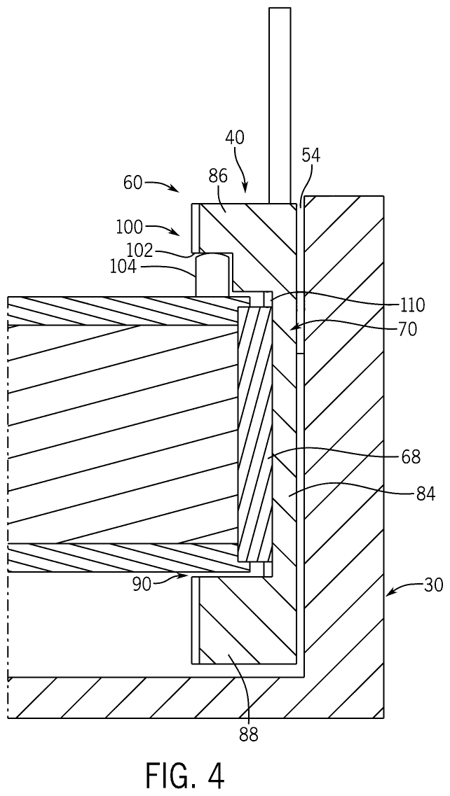

Referring now to FIG. 4, a portion of stator body 36, shown as stator yoke 68, is nested within channel 90 of winding module 40. Adhesive 110, which may be an epoxy or other resin, adheres or attaches the module body's 70 intermediate portion 84 to the outer surface of stator yoke 68. Receptacle 102 receives post 104 to further mechanically interlock the winding module 40 and stator body 36.

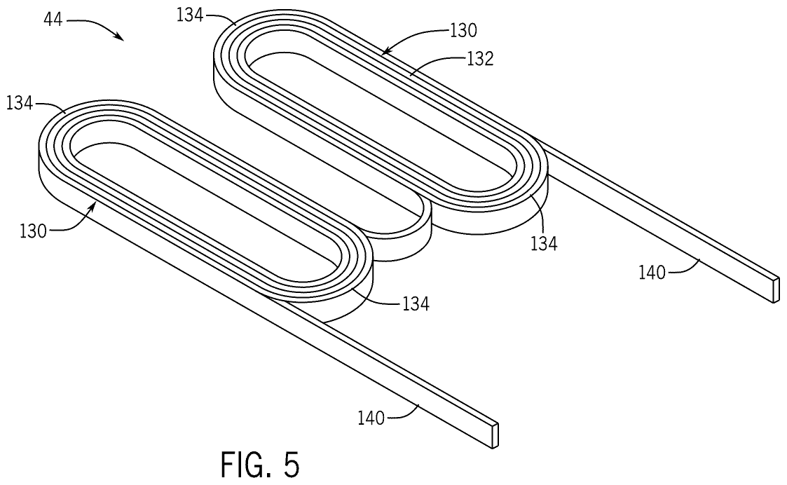

Referring now to FIG. 5, windings 44 are shown having straight winding sections 132 with lengths of the winding conductors arranged along a straight-line path and end winding loops 134 that include lengths of winding conductors arranged in curved paths at the ends of the winding(s) 44. Terminal sides of the end windings or winding loops 134 may be bent radially inward or outward to improve airflow and provide a compact form. The winding's 44 terminals 140 may be electrically connected to other components such as sequentially or otherwise connected to other windings 44, the motor terminal box, or various connector lugs.

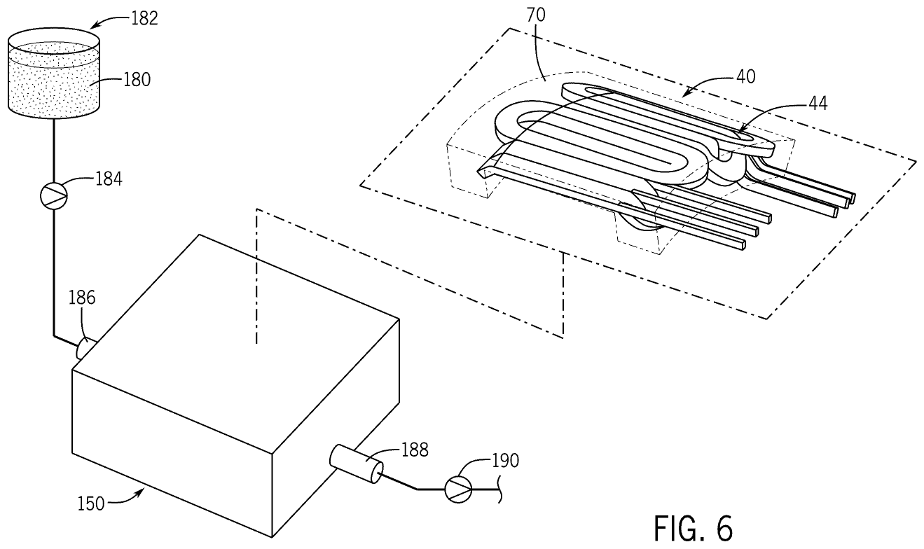

FIG. 6 generally represents a method(s) of making winding module 40. Winding(s) 44 is shown placed inside a cavity of mold 150. Insulative material such as epoxy 180 is delivered from its storage container 182 by way of pump 184 into mold 150 through a hose fitting 186 at an inlet end of mold 150. An outlet end of mold 150 includes vacuum port 188 through which vacuum pump 190 draws a vacuum to evacuate contents from the void space of mold 150. This impregnates windings 44 with the epoxy 180 by filling the void space(s) within mold 150, including space(s) between the coils of conductive material(s) of windings 44. After the epoxy cures, windings 44 are integrated within module body 70 to provide the winding module 40.

While the invention has been described in the context of aircraft propulsion it will be appreciated that it has broad use for any application where short periods of high power output are required of the motor. Further, in the aviation application, it will be appreciated that the present invention can be used as the sole prime mover without the primary engine 14 accommodating both normal power requirements during flight and episodic high-power requirements during takeoff.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A slotless electric motor comprising:
a rotor mounted for rotation about an axis;
a stator positioned adjacent to the rotor and having a central axis coaxially aligned with the rotor axis of rotation; the stator providing:
a stator body having a circumferential side wall and a first face and a second face providing a pair of parallel outer surfaces of the stator body that extend from the circumferential side wall radially inwardly toward the stator central axis;
a segmented winding assembly providing multiple winding modules attached to each other and extending about the stator body, each winding module providing a module body made from an insulative material and that includes:
a first side wall facing a first adjacent winding module;
a second side wall facing a second adjacent winding module;
an outer segment arranged away from the stator body;
an inner segment arranged toward the stator body; and
an interlock system configured to mechanically locate the module body in parallel alignment with the stator central axis.

2. The slotless electric motor of claim 1 wherein:
the circumferential side wall of the stator body is defined by a stator yoke; and
the interlock system comprises:
a chamber provided in the inner segment of the module body and receives a portion of the stator yoke to radially nest the portion of the stator yoke within a respective portion of the module body.

3. The slotless electric motor of claim 2 wherein:
each module body includes:
a first end portion at a first end of the module body;
a second end portion at a second end of the module body;
an intermediate portion between the first and second end portions of the module body with the chamber defined at the intermediate portion of the module body;
and the chamber is defined between the first and second end portions of the body module.

4. The slotless electric motor of claim 3 wherein the winding modules comprise:
straight winding sections that include lengths of winding conductors arranged along a straight-line path and encapsulated within the intermediate portion of the module body; and
end winding loops that include lengths of winding conductors arranged in a curved path with respect to the straight winding sections and encapsulated within the first and second end portions.

5. The slotless electric motor of claim 4 wherein:
the intermediate portion of the module body defines an intermediate thickness dimension;
the first end portion of the module body defines a first end thickness dimension; and
the second end portion of the module body defines a second end thickness dimension;
each of the first and second end thickness dimensions is greater than the intermediate thickness dimension.

6. The slotless electric motor of claim 5 wherein the first end thickness dimension is the same as the second end thickness dimension.

7. The slotless electric motor of claim 5 wherein:
the first end portion of the module body defines a first block that extends radially closer to the stator central axis than the intermediate portion of the module body; and
the second end portion of the module body defines a second block that extends radially closer to the stator central axis than the intermediate portion of the module body.

8. The slotless electric motor of claim 7 wherein:
the first block is arranged outwardly beyond the first face of the stator body; and
the second block is arranged outwardly beyond the second face of the stator body.

9. The slotless electric motor of claim 8 wherein:
the chamber is defined by a channel between the first and second blocks of the module body.

10. The slotless electric motor of claim 1 wherein the interlock system comprises:
an alignment interlock providing a mechanical engagement between the module body and the stator body that locates the module body in a predetermined position with respect to the stator body.

11. The slotless electric motor of claim 10 wherein the alignment interlock includes:
a projection extending from a first surface of one of the module body and the stator body; and
a receptacle extending into a second surface of the other one of the module body and the stator body.

12. The slotless electric motor of claim 11 wherein:
the module body includes:
a block arranged at an end of the module body; and
an intermediate portion adjacent to and thinner than the block; and
the intermediate portion of the module body is attached to the circumferential side wall of the stator body;
the block of the module body is adjacent and overlies a portion of one of the first and second faces of the stator body; and
the alignment interlock provides engagement between the block of the module body and the respective one of the first and second faces of the stator body.

13. The slotless electric motor of claim 12 wherein:
the block is a first block arranged at a first end of the module body;
a second block is arranged at a second end of the module body; and
the alignment interlock comprises:
a projection that extends outwardly from the first face of the stator body; and
a receptacle formed in the first block receiving the projection with engagement of the receptacle and projection locating the module body with respect to the stator body.

14. The slotless electric motor of claim 13, the interlock system further comprising:
a channel defined by respective surfaces of the first block, the second block, and the intermediate portion of the module body, the channel receiving a portion of the stator body with the portion of the stator body received in the channel sandwiched between the first and second blocks.
